(19) United States
(12) Patent Application Publication
(10) Pub. No.: US 2017/0248919 A1
(43) Pub. Date: Aug. 31, 2017

(54) WRIST WATCH OR THE LIKE

(71) Applicant: ZERO S.A., Chiasso (CH)

(72) Inventor: Tarcisio TASSO, Chiasso (CH)

(21) Appl. No.: 15/500,151

(22) PCT Filed: Jul. 30, 2015
(86) PCT No.: PCT/IB2015/055756

§ 371 Date: Jan. 30, 2017

(30) Foreign Application Priority Data
Jul. 30, 2014 (IT) MO2014A000224

(51) Int. Cl. G04B 19/14; G04B 37/05

(52) U.S. Cl. CPC G04B 19/14; G04B 37/052

(57) ABSTRACT

A wrist watch or the like having a case comprising at least an internal housing having at least a front opening. A dial is inserted in the housing, arranged in the proximity of the front opening and facing outwards. A horology mechanism is housed in the housing and is operatively connected to the dial, the horology mechanism having at least one support linked together with the case and having at least a seat able to house the mechanism.

### TECHNICAL FIELD

The present invention relates to a watch, particularly a wrist watch or the like.

### BACKGROUND ART

Generally, a watch is formed by a bearing case within which are contained a working mechanism and a dial with hands to indicate the hours and minutes.

The case generally consists of three parts: an upper transparent part called “crystal”, a central body called “case middle” and a lower part called “back”.

The back is the lower part of the case and constitutes the bottom of the structure that contains and protects the watch mechanism.

The watch mechanism is the set of parts that allow to perform the main function of the watch, that is marking time.

Generally, a horology mechanism is constituted by a set of wheels and pinions which, once loaded, give rise to oscillatory movements which result in periodic rotations of the hands.

A mechanism usually comprises a substantially disc-shaped casing inside which are housed the various mechanical parts.

It is well known that the mechanism is inserted into the case and is fixed to the back of the dial by means of suitable fastening means able to retain the mechanism itself to the dial. The latter is housed to measure in the case and snap-fixed or fixed by means of fixing elements.

In addition, between the back and the mechanism is placed a shim able to lock the mechanism on the dial, so as to minimize the movements of the mechanism itself inside the case.

This known technique has some drawbacks.

A first drawback is linked to the fact that the mechanism, so inserted, is affected by shocks and vibrations transferred by the case to the mechanism itself. This requires a high resistance of the materials with which to make the various components of the mechanism, with a consequent increase in costs.

Another drawback is linked to the use of the shim, necessary to prevent the mechanism from moving inside the case.

This implies the use of an additional piece which complicates the watch assembly and disassembly operations.

### DESCRIPTION OF THE INVENTION

The main aim of the present invention is to provide a wrist watch or the like which allows optimal fixing of the mechanism inside the case.

Another object of the present invention is to provide a wrist watch or the like which ensures the mechanism is protected against knocks.

Another object of the present invention is to provide a wrist watch or the like which allows the insertion of the mechanism and its fixing in the case with simple and fast assembly and disassembly operations.

Another object of the present invention is to provide a wrist watch or the like which allows to overcome the mentioned drawbacks of the prior art within the ambit of a simple, rational, easy, effective to use and affordable solution.

The objects stated above are achieved by the present wrist watch or the like according to claim 1.

### BRIEF DESCRIPTION OF THE DRAWINGS

Other characteristics and advantages of the present invention will become better evident from the description of a preferred but not exclusive embodiment of a wrist watch or the like, illustrated by way of an indicative, but non-limiting example in the accompanying drawings, in which:

FIG. 1 is an axonometric view from above of the watch according to the invention;

FIG. 2 is an axonometric view and in partial section of the watch according to the invention;

FIG. 3 is an exploded view of the watch according to the invention, in a first embodiment;

FIG. 4 is an exploded view of a detail of the watch according to the invention, in a first embodiment.

FIG. 5 is an exploded view of a detail of the watch according to the invention, in a second embodiment.

### EMBODIMENTS OF THE INVENTION

With particular reference to such illustrations, globally indicated with reference number 1 is a watch of the type of a wrist watch. Different embodiments cannot however be ruled out.

The watch 1 comprises at least a case 2, a dial 3 and a horology mechanism 4.

The case 2, formed by the case middle 5 and by the back 6, comprises at least an internal housing 7 having at least a front opening 8.

In this specification the words “front”, “rear” and the like refer to the point of view of an observer during the normal use of the watch.

The dial 3 is inserted in the housing 7, arranged in the proximity of the front opening 8 and facing outwards.

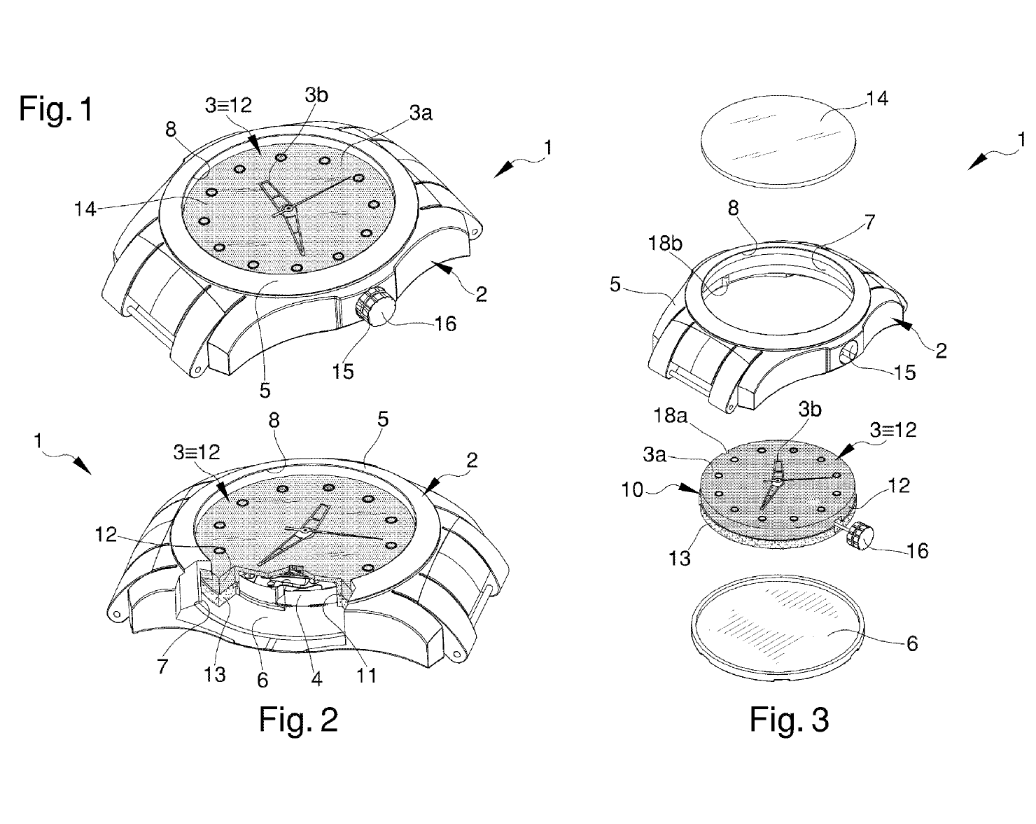

As illustrated in FIG. 1, the surface 3a on which hours are shown and the hands 3b are turned outwards, so as to be able to be seen by the user through the crystal 14.

The case 2 and the hands 3b are advantageously made of plastic material, but alternative embodiments cannot be ruled out wherein these components are made with alternative materials.

The horology mechanism 4 is housed, in fact, in the housing 7 and is operatively connected to the dial 3.

In particular the hands 3b are connected to the mechanism 4 by means of one or more shafts 9 which transform the oscillating motion of the mechanical parts of the mechanism 4 into the typical periodical rotary motion of the hands of a watch.

The watch 1 comprises at least a support 10 that is linked together with the case 2 and has at least a seat 11 able to house the mechanism 4.

In particular, the support 10 covers the mechanism 4 and is placed between the mechanism 4 itself and the walls of the case 2.

The support 10 comprises at least a front portion 12 and at least a rear portion 13, with the rear portion 13 which is associated with the front portion 12 to define the seat 11.

In particular, as shown in FIG. 2, the front and rear portions 12 and 13 are associated so as to form the external elements of a “sandwich” structure having the mechanism 4 as its internal element.

The front portion 12 is linked together with the case 2.

More particularly, the entire support 10 is fitted to measure into the housing 7.

In the present embodiment, the front portion 12 has a circular section, with a diameter larger than the diameter of the front opening 8.

In this way, going in abutment with the portion of the case 2 that defines the edge of the front opening 8, shifting movements are prevented of the support 10 between the back 6 and the crystal 14.

The mechanism 4 is placed between the front portion 12 and the rear portion 13. These are snap-closed so as to form the support 10.

There is a side opening 15 on it able to allow the connection between the adjusting crown 16 and the mechanism 4.

As illustrated in FIG. 3, the support 10 is inserted in the case and linked together with it.

With all the components fixed, the mechanism 4 has no chance to move inside the case.

The effects of any accidental shocks are minimized thanks to the dissipating action of the rear portion 13.

Advantageously, the support 10 is shaped so to interlock in correspondence to a respective complementary profile formed inside the case 2.

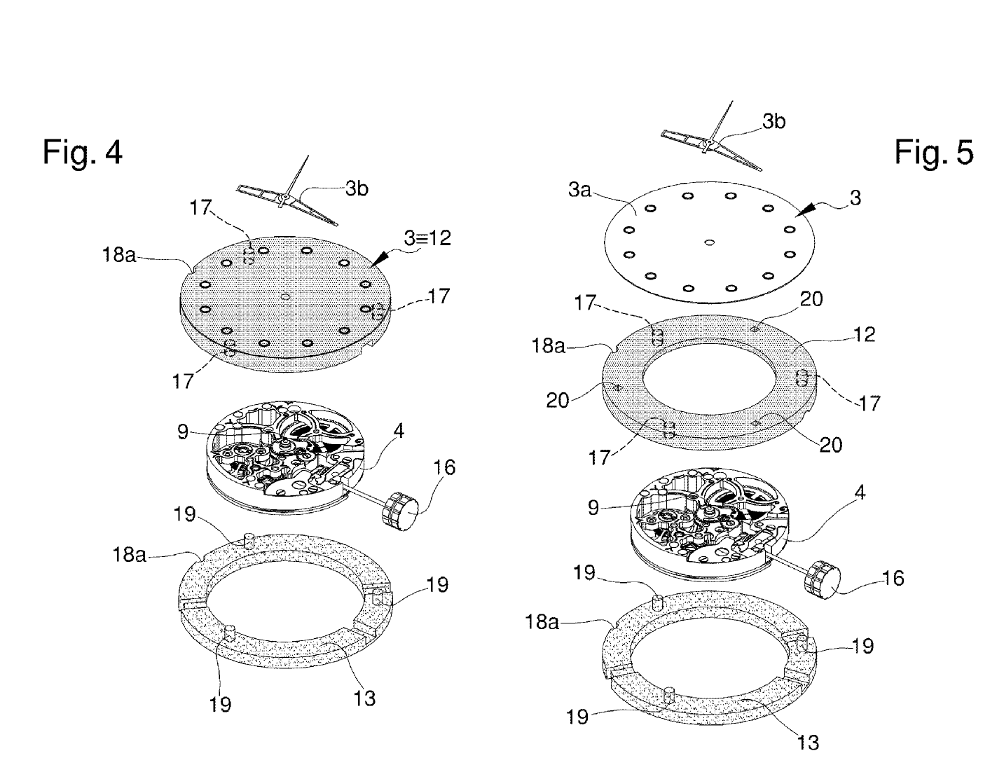

In the embodiments illustrated in FIGS. 4 and 5, the support 10 comprises a cut 18a able to couple with a projection 18b so as to further constrain the support 10 inside the housing 7.

By so doing any rotational movement of the support 10 in the plane of the back 6 is also prevented.

According to the invention, the rear portion 13 comprises an elastically deformable polymeric material.

Preferably, the entire rear portion 13 is made of an elastically deformable material.

In particular, the rear portion 13 may be composed of an elastomer, the type of rubber or a similar material.

The mechanical properties of this material cause any shocks and vibrations being dissipated and therefore damped. In this way the support 10 exerts an “anti-shock” function thus protecting the mechanism 4 in its interior.

The front portion 12 comprises a substantially rigid polymeric material.

Advantageously it is made of hard plastic material, but the use of different materials with similar properties cannot be ruled out.

With reference to a first embodiment illustrated in FIGS. 1 to 4, the rear portion 13 has the shape of a circular through ring, with inner diameter able to surround the outer wall of the mechanism 4.

The support 10 comprises coupling means 17, 19 between the front portion 12 and the rear portion 13 and therefore able to join the two portions 12 and 13 which form the casing containing the mechanism 4.

In the present embodiments the coupling means 17, 19 are the type of interlocking coupling means.

In particular, as shown in FIGS. 4 and 5, the coupling means 17, 19 comprise at least a recess 17 and at least a protruding element 19.

In the embodiments illustrated in FIG. 4 and FIG. 5 the protruding elements 19 are part of the rear portion 13 and are intended to be fitted into the recesses 17 present in the front portion 12.

Embodiments are not ruled out wherein the protruding elements 19 are part of the front portion 12, with the recesses 17 formed in the rear portion 13, or embodiments which provide a mixed solution between the previous two, that is, with recesses 17 and protruding elements 19 present on both portions 12 and 13. In a first embodiment, illustrated in FIG. 4, the front portion 12 also has a full body disc shape.

In this embodiment the front portion 12 comprises the dial 3. In particular, the dial 3 and the front portion 12 are made in a single body piece, preferably of hard plastic material.

In this way it is possible to reduce the number of parts to be inserted into the case, by simplifying the assembly and disassembly operations, as well as reducing production costs.

In a second embodiment, illustrated in FIG. 5, the support 10 has the shape of a through ring.

In this case it comprises fixing means 20 of the dial 3, e.g. interlocking means, or adhesive means, or the like, able to retain the dial 3 on the front portion 12.

In particular, in this second embodiment, the front portion 12 and the dial 3 are not made in a single body piece, but the dial 3 is fixed to the front portion 12 by means of the fixing means 20.

In this way it is possible to diversify the support 10, being able to use a dial 3 of different material, shape and color.

It has in practice been found how the described invention achieves the intended objects and in particular the fact is underlined that the watch ensures an optimum fixing of the mechanism inside the case and a protection of the same from shocks, while still allowing simple and fast assembly and disassembly operations.

All this while remaining within the ambit of a simple and affordable solution.

1. A wrist watch or the like, comprising:
at least a case comprising at least an internal housing having at least a front opening;
at least a dial inserted in said housing, arranged in the proximity of said front opening and facing outwards;
at least a horology mechanism housed in said housing and operatively connected to said dial; and
at least one support linked together with said case, said support having at least a seat able to house said mechanism.

2. The watch according to claim 1, wherein said support comprises at least a front portion and at least a rear portion, with said rear portion associated with said front portion to define said seat.

3. The watch according to claim 2, wherein said front portion is linked together with said case.

4. The watch according to claim 2, wherein said rear portion comprises an elastically deformable polymeric material.

5. The watch according to claim 2, wherein said front portion comprises a substantially rigid polymeric material.

6. The watch according to claim 2, wherein said support comprises coupling means between said front portion and said rear portion.

7. The watch according to claim 6, wherein said coupling means are interlocking coupling means.

8. The watch according to claim 7, wherein said coupling means comprise at least a recess formed on at least one of said front portion and said rear portion and at least a protruding element inserted within said recess and formed on the other of said front portion and said rear portion.

9. The watch according to claim 2, wherein said front portion comprises said dial.

10. The watch according to claim 2, wherein said front portion and said dial are made in a single body piece.

11. The watch according claim 1, wherein said support comprises fixing means of said dial.
